(19) United States
(12) Patent Application Publication
(10) Pub. No.: US 2015/0164059 A1
(43) Pub. Date: Jun. 18, 2015

(54) HORSE HOOF BOOT

(71) Applicant: Guy F. Bartlett, Punta Gorda, FL (US)

(72) Inventor: Guy F. Bartlett, Punta Gorda, FL (US)

(21) Appl. No.: 14/627,525

(22) Filed: Feb. 20, 2015

Related U.S. Application Data
(63) Continuation-in-part of application No. 13/554,183, filed on Jul. 20, 2012.
(60) Provisional application No. 61/510,265, filed on Jul. 21, 2011.

(51) Int. Cl. A01L 15/00; A01K 13/00

(52) U.S. Cl. CPC A01L 15/00; A01K 13/007

(57) ABSTRACT

A method for treating a diseased hoof of a horse by providing a hoof boot for supporting the hoof in a position above the ground but open to air circulation to protect an afflicted frog of a horse's hoof while promoting healing of the affliction.

### CROSS-REFERENCE TO RELATED APPLICATIONS

This Application is a Continuation in Part of application Ser. No. 13/554,183 filed on Jul. 20, 2012. application Ser. No. 13/554,183 claims the benefit of U.S. Provisional Application 61/510,265 filed on Jul. 21, 2011, the contents of which are incorporated herein in their entirety.

### FIELD OF THE INVENTION

The present invention is directed to the care of animals and more particularly to a method of treating to aid in the cure of diseases and injuries to the hoofs of horses.

### BACKGROUND OF THE INVENTION

The frog of a horse hoof is a rubbery-like material extending from the middle to the back of the hoof. During movement of the horse, the frog serves as somewhat of a shock absorber as the hoof hits the ground, but also as a part of the circulatory system of the horse. In particular, the frog facilitates the pumping of blood through the foot of the horse and back up the leg. Accordingly, the frog is an essential part of the hoof on which proper health of the horse depends.

In some cases, the frog may become prone to bacterial or fungal infection. An example of such a bacterial infection is thrush, which can occur as a result of unkempt conditions, such as a muddy stall or other conditions in which oxygen levels at the horses hooves are low. Severe infection of the frog may cause lameness often requiring euthanasia of the ailing horse.

This and other afflictions of the frog can cause the frog to drop or droop below the sole of the hoof. Softening of the hoof also may occur making it difficult to properly attach a horse shoe to the hoof, or otherwise, to maintain attachment of the shoe.

Various hoof boots and apparatuses that attach to the hoof are known. Such boots and apparatuses, however, generally include structure that applies pressure to the frog so as to disallow proper healing when the frog droops below its regular positioning. No boots have heretofore have been provided structured for the purpose of maintaining the frog above the surface over which the horse is walking or even running.

Thus, it would be advantageous to provide an apparatus that supports the hoof without applying pressure to the frog to thereby allow proper healing of the frog and mobilization of the horse when such drooping occurs.

### SUMMARY OF THE INVENTION

Such an advantage is realized by the present invention that provides a hoof boot that alleviates pressure on the frog.

The present invention provides a method for curing a horse with a drooping frog including a boot for accommodating a hoof of a horse, and more specifically, to a boot constructed to alleviate pressure on the frog of the hoof so as to allow healing of the frog, and at the same time, providing for adequate mobilization of the horse while the healing process occurs.

More particularly, the present method includes providing hoof boot that includes an interior shelf supporting the hoof without contacting the frog and positioning the frog well away from the ground. On its bottom surface, the boot includes a sole containing a sole cutout in the vicinity of the frog so that the frog is substantially pressure free when the boot is fitted to the hoof and the frog, even if it has dropped from its normal position, is out of contact with the ground as the horse moves about. When fitted with the boot of the present invention, therefore, a method can be utilized to adequately support the hoof when the boot comes into contact with the ground without causing pressure on the frog. Accordingly, healing of the frog and mobilization of the horse are optimized.

### BRIEF DESCRIPTION OF THE DRAWINGS

A better understanding of the hoof of the present invention can be had upon reference to the following drawings in which like reference numerals refer to like parts throughout the several view and in which :

FIG. 1 is a top and side perspective view of the hoof boot of the present invention, including illustration of the relative placement of a horse hoof into the hoof boot;

FIG. 2 is a bottom and side elevated perspective view of the hoof boot of the present invention with parts of the boot shown in exploded view; and

FIG. 3 is a cross-sectional view taken along lines 3-3 of FIG. 2 showing a sole portion and a partial upper hoof boot portion extending above the sole of the hoof boot.

### DETAILED DESCRIPTION OF THE PREFERRED EMBODIMENT

The present invention provides a method including a horse hoof boot for use in treating an affliction of the hoof of a horse, and more particularly, where the affliction causes a portion of the frog of the hoof to droop at the center of the hoof.

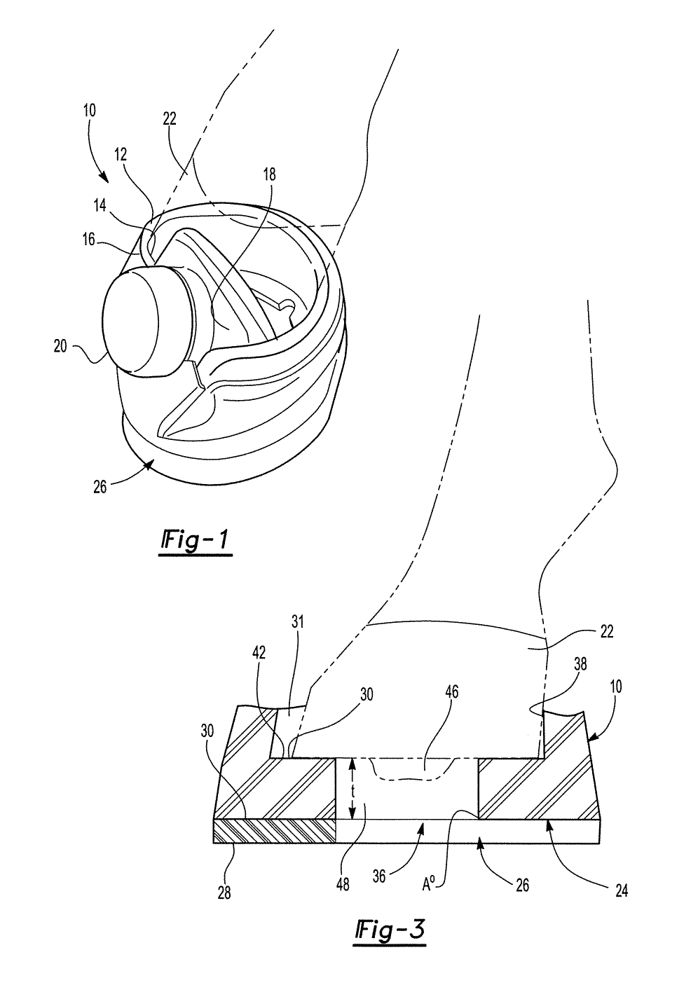

Referring first to FIG. 1, there is shown the horse hoof boot 10 of the present invention, which includes a hoof housing 12 comprising rubberized, or similar material, interior and exterior surfaces 14 and 16, respectively. A tongue 18 and adjustment mechanism 20 are also provided for facilitating placement and retention/removal of the boot 10 relative to the horse hoof 22.

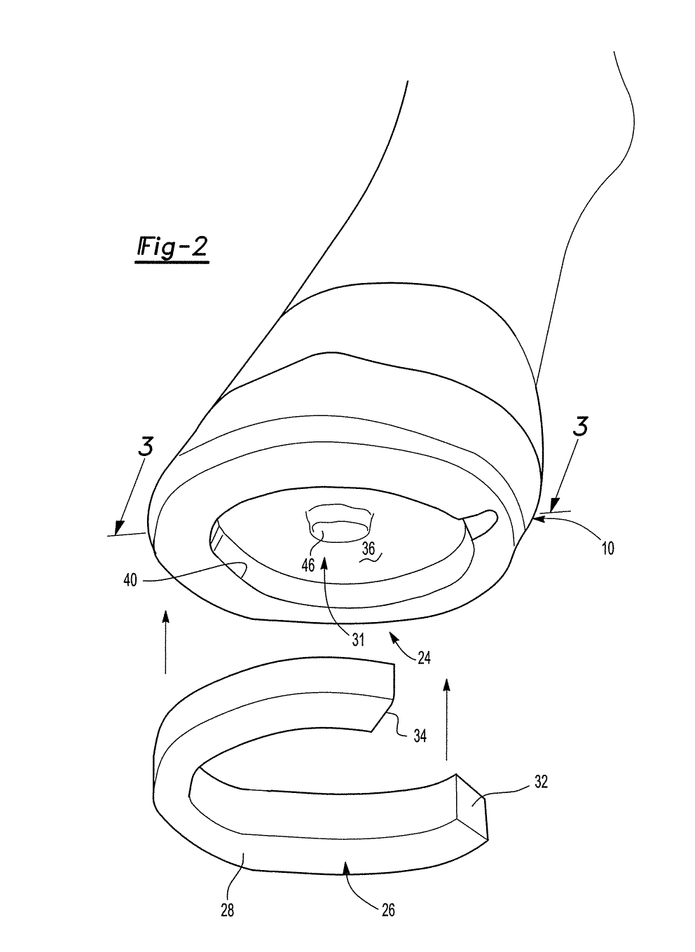

As best seen in FIGS. 2 and 3, a sole 26 is provided to be attached to an underside 24 of the boot 10. The sole 26 includes a bottom face 28 disposed toward the exterior of the boot 10 and an upper face 30 disposed toward the interior 31 of the boot 10. The sole 26 is preferably in the form of a horse shoe and is intended to be secured to the bottom face 24 of the boot 10 so that the gap between the ends 32 and 34 of the horseshoe shaped sole 26 is at the rear of the boot 10 when a horse's hoof 22 is properly positioned within the boot 10. Although the sole 26 is shown as a separate piece to be adhered to the bottom face of the boot 10 it should be clear that it would be within the scope of the present invention to mold the sole 26 integrally with the remaining portion of the boot 10. The sole 26 is preferably constructed of hard rubber or a similar material which will take the wear and tear of use but which will still provide some cushion to the hoof 22 of the horse during use.

As best seen in FIG. 3, the boot 10 is provided with a central opening 36 which extends through the boot 10 and which is enlarged in its upper portion to accommodate the hoof 22 of a horse and to provide a shelf 30 upon which the hoof 22 is seated when the boot 10 is in place on the horse's hoof 22. The enlarged upper portion is defined in part by an upper opening 38 which is larger than a lower opening 40. The shelf 30 forms a support surface 42 in the interior of the boot 10 to support an afflicted hoof 22 which may have a frog 46, which has drooped as shown in FIGS. 2 and 3, high enough away from the sole 26 so as prevent the afflicted frog 46 from coming into contact with the ground.

It is important that the boot 10 be securely positioned on the hoof 22 of the horse. The adjusting mechanism 20 provides a means of securely locking the boot 10 to the hoof 22. Turning the knob of the mechanism 20 tightens the boot 10 around the hoof 22. If the hoof 22 has not deteriorated the sole 26 can be attached to the hoof 22 by nails in the manner that an ordinary horseshoe is attached to the horse's hoof 22. This, too, will insure that the boot 10 is securely locked in place.

It should be apparent that the horse shoe shape of the sole 26 permits air to circulate through the lower open back portion 48 of the boot 10 to the afflicted frog to aid in the healing process. Also if the affliction has not affected the bottom of the horse's hoof the sole 26 can be nailed to the hoof of the horse in the nature of a horseshoe to more securely mount the boot 10 to the horse's hoof 22. Also although the boot 10 and the sole 26 have been described as being constructed of a “rubberized” material other materials such as hard rubber or similar materials could be used to construct the boot 10 as well.

Accordingly, by providing a hoof boot including an open center portion as described in the present application and a shelf formed in the upper open portion to position the hoof above the ground, the overall health of the horse hoof is promoted in instances in which the frog is afflicted in a way or ways causing portions thereof to droop as discussed above. The open center, as well as the horse shoe shape of the sole permits air to be circulated to the frog to promote healing. Also it is not necessary to remove the boot each time medicine is to be applied to the afflicted frog. Moreover, mobilization of the horse necessary to the health of the horse, and particularly of the afflicted leg of the horse, is promoted all the while allowing the afflicted frog to remain above, and thus off of the ground.

It should be understood that it is hoped that use of the boot 10 will provide a means for promoting a cure for the afflicted horse but in some situations cure is not going to be possible. The use of the boot 10 however will prolong the life of the horse where a cure is not possible by permitting the horse to move around without pain. In such situations the boot 10 may become necessary for the remaining life of the animal.

Such a situation may occur when the horse has laminitis. A horse with this condition is termed a foundered horse. The condition is characterized by the coffin bone of the horse rotating within the hoof capsule and then dropping along with the frog to a position below the sole of the hoof of the afflicted horse. If not caught early laminitis cannot be cured and results in the horse becoming lame. If the affliction reaches this stage it has heretofore been necessary to destroy the horse.

While a particular boot 10 has been provided for use in the method of the present invention it is clear that boots other than the boot 10 could be used. A boot constructed with the shelf or its equivalent to hold the frog of the horse above the ground could be used in the method of the present invention.

The method of the present invention provides a means to prolong the life of a horse afflicted with laminitis although in such a situation use of the boot will not result in a cure and and may require the boot to be worn permanently.

A method for treating a diseased hoof of a horse has been disclosed which includes providing a hoof boot for supporting the hoof in a position above the ground but open to air circulation to protect an afflicted frog of a horse's hoof while promoting healing of the affliction.

It is apparent that a method has been provided for treating a horse having an afflicted frog that extends below the hoof comprising the steps of providing a boot with an interior shelf spaced from the bottom of the boot with the shelf being spaced sufficiently from the bottom of the boot to maintain the frog within the boot when the boot is positioned on the hoof of the horse. The method includes placing the boot on the hoof of the horse and leaving the boot in place until the afflicted frog heals.

I claim:

1. A method of treating a horse having a hoof and an afflicted frog that extends below the hoof comprising the steps of;
a) providing a boot with an interior shelf spaced from the bottom of the boot
b) the shelf being spaced sufficiently from the bottom of the boot to maintain the frog within the boot when the boot is positioned on the hoof of the horse
c) placing the boot on the hoof of the horse and leaving the boot in place as long the afflicted frog extends to a position in contact with the ground with the boot removed.

2. The method as defined in claim 1 including the step of maintaining the boot on the horse's hoof until the frog of the horse is cured.

3. The method as defined in claim 1 including the step of providing a boot with a shelf that positions the frog of the horse above the ground.
